(19) United States
(12) Patent Application Publication
(10) Pub. No.: US 2014/0318367 A1
(43) Pub. Date: Oct. 30, 2014

(54) Insulating Gas Boundary Layer for Internal Combustion Engines

(71) Applicant: Gregory S. Mungas, Mojave, CA (US)

(72) Inventor: Gregory S. Mungas, Mojave, CA (US)

(73) Assignee: Firestar Engineering, LLC, Mojave, CA (US)

(21) Appl. No.: 14/212,193

(22) Filed: Mar. 14, 2014

Related U.S. Application Data
(60) Provisional application No. 61/782,337, filed on Mar. 14, 2013.

(51) Int. Cl. F16J 1/00

(52) U.S. Cl. CPC F16J 1/005
USPC 92/169.1; 92/261

(57) ABSTRACT

A cylinder has an insulating gas boundary layer (IGBL) across the cylinder wall inner surface, the IGBL formed by injection of an insulator fluid into the combustion chamber of the cylinder. In one implementation, a pressure differential is engineered between the top region of the cylinder and the bottom region of the cylinder. In yet another implementation, the insulator injection pressure is temporally modified in synchronicity with the piston cycle and/or in accordance with other temporal factors to provide appropriate IGBL coverage.

### CROSS-REFERENCE TO RELATED APPLICATION

This application claims the benefit of U.S. Provisional Application No. 61/782,337 filed Mar. 14, 2013, the entire contents of which are incorporated herein by reference for all purposes.

### BACKGROUND

Modern internal combustion engines represent a portfolio of mature technologies. However, such technologies are approaching the limits of chamber and piston materials, effective fuels, and control. For example, solid insulating materials have proven insufficiently robust and insufficiently insulating for some higher temperature operations. Furthermore, solid insulating materials have proven susceptible to corrosion and/or degradation from either the temperatures and/or chemically oxidizing/reducing environments within existing combustion chambers.

### SUMMARY

Among other things, implementations described and claimed herein address the foregoing problems by providing an insulating gas boundary layer (IGBL) across the interior cylinder surface by injection of an insulator fluid (e.g., a coolant, such as water or gas; a chemically neutral buffer fluid) into the combustion chamber of the cylinder. In one implementation, a pressure differential is engineered between the top region of the cylinder and the bottom region of the cylinder. In yet another implementation, the insulator fluid injection pressure is temporally modified in synchronicity with the piston cycle and/or in accordance with other temporal factors to provide appropriate IGBL coverage.

One particular implementation of this disclosure is an assembly that includes a cylinder having an inner surface and a combustion chamber, a piston moveably positioned in the cylinder, an insulator fluid and an insulator fluid source, and one or more insulator fluid injection ports in the inner surface of the cylinder, the ports in fluid communication with the insulator fluid source and configured to transfer the insulator fluid into the cylinder in a gas phase, the gas phase forming an insulating gas boundary layer between the inner surface of the cylinder and the combustion chamber.

Another particular implementation of this disclosure is a cylinder having a cylinder wall having an inner surface encompassing a combustion chamber, one or more insulator fluid injection ports along the inner surface of the cylinder wall, and one or more insulator fluid passages configured to receive insulator fluid and transfer the insulator fluid through the one or more insulator fluid ports in a gas phase, the gas phase insulator fluid forming an insulating gas boundary layer on an interior surface of the combustion chamber.

Yet another particular implementation of this disclosure is a method that includes injecting an energetic working fluid into a combustion chamber of a cylinder, igniting the energetic working fluid in the combustion chamber, and injecting insulator fluid in gas phase into the cylinder, the gas-phase insulator fluid forming an insulating gas boundary layer between an inner surface of the cylinder and the combustion chamber. In some implementations, the insulating gas boundary layer forms a temperature differential in the insulating gas boundary layer. In some implementations, the injection of the insulator fluid is temporally modified in synchronicity with a piston cycle.

These and various other features and advantages will be apparent from a reading of the following detailed description of implementations described and recited herein.

### BRIEF DESCRIPTIONS OF THE DRAWINGS

A further understanding of the nature and advantages of the present invention may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 is a schematic depiction of an example system including a IGBL-injecting piston and cylinder.

FIG. 2 schematically depicts, in cross-sectional view, an example IGBL-injecting piston and cylinder assembly for an internal combustion engine.

FIG. 3 schematically depicts, in cross-sectional view, an alternative example IGBL-injecting piston and cylinder assembly for an internal combustion engine.

FIG. 4 schematically depicts, in cross-sectional view, another alternative example IGBL-injecting piston and cylinder assembly for an internal combustion engine.

FIG. 5 schematically depicts, in cross-sectional view, another alternative example IGBL-injecting piston and cylinder assembly for an internal combustion engine.

FIGS. 6A and 6B schematically depict cross-sectional side views of alternate examples of fluid passages through a cylinder wall.

FIGS. 7A, 7B, and 7C schematically depict, in cross-sectional view, an example IGBL-injecting piston and cylinder assembly shown at three different stroke positions.

FIG. 8 is a partial perspective view of a cylinder wall for an IGBL-injecting assembly.

FIG. 9 is a graphical representation of the relationship of pressure ratio to piston expansion ratio.

FIG. 10 schematically depicts, step-wise, an example process producing a porous media structure.

FIG. 11 schematically depicts a step from another example process for producing a porous media structure.

FIG. 12 schematically depicts, step-wise, another example process for producing a porous media structure.

FIG. 13 schematically depicts a step from another example process for producing a porous media structure.

FIG. 14 schematically depicts, in side view, a tiered porosity structure.

FIG. 15 schematically depicts, step-wise, another example process for producing a porous media structure.

FIG. 16 is a flow chart of example operations for injecting a fluid into an internal combustion chamber of a piston and cylinder assembly, the fluid being one that creates an insulating gas boundary layer.

### DETAILED DESCRIPTION

The present disclosure is directed to systems and methods for forming an insulating gas boundary layer (IGBL) in the interior volume of a cylinder in a combustion engine by injecting a fluid (e.g., a coolant, such as water or gas; a chemically neutral buffer fluid) into the combustion chamber of the cylinder. The injected fluid is a gas or liquid that converts to an insulating gas, protecting the cylinder surface from the high temperatures and/or corrosive gas chemistry encountered within the cylinder. In general, the IGBL protects the cylinder sidewalls and the top wall from the high temperatures experienced during combustion, allowing the cylinder to be formed from lower temperature-resistant materials than if no IGBL were present. In some implementations, however, a portion of the cylinder (e.g., the top wall) may be formed from a high temperature-resistant material.

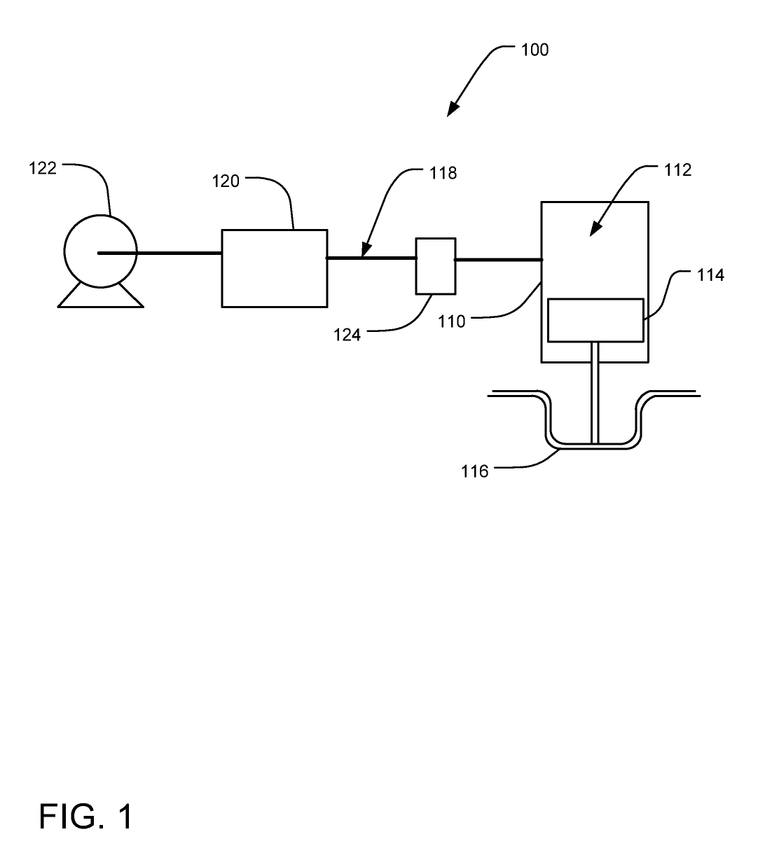

In FIG. 1, an exemplary system 100 is illustrated. This system 100 includes an IGBL-injecting piston and cylinder and some of the peripheral equipment that allows the insulating gas boundary layer to form in the cylinder. Turning to FIG. 1, system 100 includes a combustion cylinder 110 having an interior volume 112 in which is positioned a piston 114 that is operably connected to a crankshaft 116. Although typically cylinder 110 has a round cross-section (i.e., it is cylindrical), in some implementations cylinder 110 may have an oval or other cross-sectional shape. Although not shown in FIG. 1, cylinder 110 includes a fuel inlet or injector, an air inlet, and an exhaust port. In fluid communication with interior volume 112, via conduit 118, is an accumulator 120. Accumulator 120 may be, for example, a tank, cylinder, or other reservoir to retain a volume of fluid therein. A pump 122 provides fluid to accumulator 120. In other systems, a compressor may be used in lieu of pump 122. System 100 includes appropriate piping, venting, valves, sensors, etc., which are not shown. In some implementations, a regulator 124 may be present upstream or downstream of accumulator 120, to regulate the flow of fluid to cylinder 110.

Together, pump 122, accumulator 120, optional regulator 124 and conduit 118 provide a flow of fluid to interior volume 112 of cylinder 110. This fluid is one that creates an insulating gas boundary layer in cylinder 110, as described herein below.

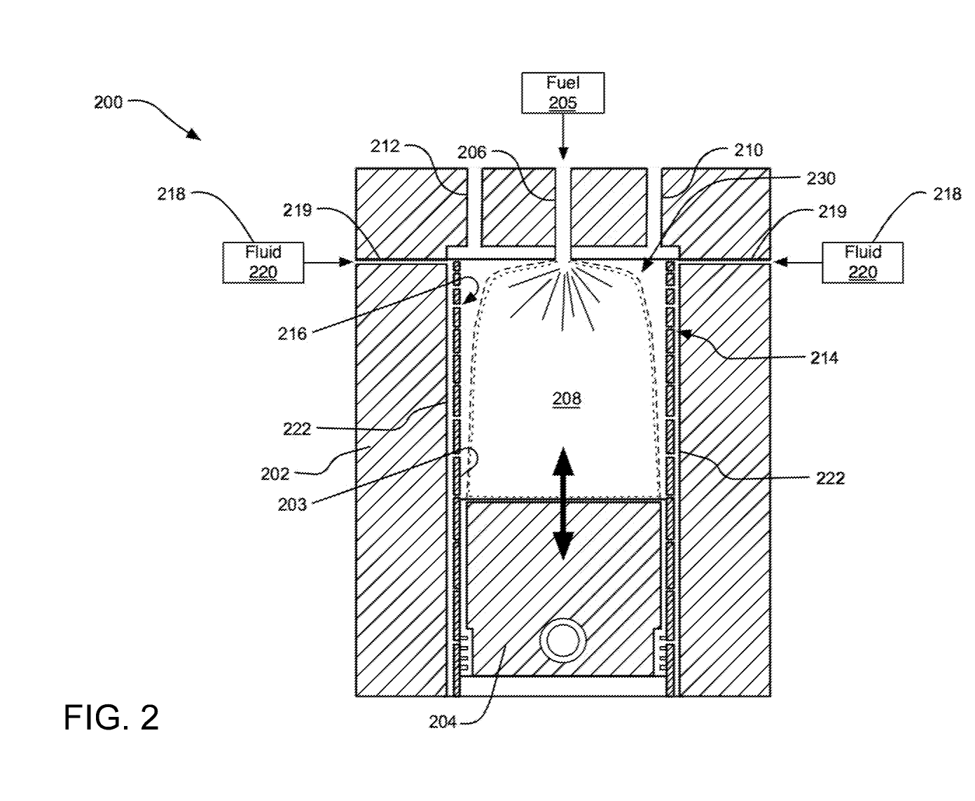

FIG. 2 depicts an example IGBL-injecting piston and cylinder assembly 200 for an internal combustion engine. Assembly 200 includes cylinder 202, having an inner surface 203, and a piston 204 positioned within cylinder 202, configured to move in and out of the interior of cylinder 202 in a cyclical manner. An energetic working fluid 205 (e.g., a fuel or a fuel/air mixture) is injected through a fluid inlet 206 into a combustion chamber 208 of cylinder 202. As energetic working fluid 205 enters combustion chamber 208, in a power stroke cycle of the internal combustion engine, energetic working fluid 205 is ignited near top dead center (TDC) of the piston movement, causing an expansion of gases that forces piston 204 down toward bottom dead center (BDC) of the piston movement. The piston and cylinder assembly 200 may also include an exhaust port 210 and an air intake port 212 for cylinder 202.

Example energetic working fluids may include without limitation fuel and oxidizer mixtures, nitrous oxide and fuel mixtures, a nitrous-oxide fuel blend, gasoline and air mixtures, diesel fuel and air mixtures, ethanol and air mixtures, monomethyl hydrazine, etc. In some implementations, the fuel and the oxidizer are both injected through fluid inlet 206. In other implementations, the fuel and oxidizer are injected into combustion chamber 208 through different inlets. Examples of such bipropellant configurations include air and fuel, nitrous oxide and fuel, oxygen and fuel, hydrogen peroxide and fuel, nitrogen textroxide and fuel.

IGBL-injecting piston and cylinder assembly 200 includes a cooling system for cylinder 202 and combustion chamber 208. In general, high temperature combustion gases may have less thermal resistance to heat flow from the combustion gases into inner surface 203 of cylinder 202 than cooler inert gases with controlled flow patterns designed to minimize convection cell interactions with inner surface 203. The cooling systems of this disclosure, in general, are designed to minimize heat and mass transport between the combustion gases in combustion chamber 208 and inner surface 203 of cylinder 202, thus protecting inner surface 203 from the high temperatures and/or corrosive gas chemistry encountered within cylinder 202.

Cylinder 202 includes one or more fluid passages 214 through its wall that terminate at a port 216 on inner surface 203. In some implementations, fluid passage(s) 214 and port(s) 216 may additionally be present through or at the top of cylinder 202. Each of fluid passages 214 and ports 216 is in fluid communication with a fluid source 218 for an insulator fluid 220, such as water or a chemically neutral buffer fluid. Example insulator fluids may include without limitation water, hydrocarbon fuels, air, carbon dioxide, nitrogen, etc. Insulator fluid 220 is either a gas or a liquid that converts to gas.

To form an insulating gas boundary layer (IGBL) in cylinder 202, particularly between inner surface 203 and combustion chamber 208, insulator fluid 220 is provided (e.g., injected) into cylinder 202 via a conduit 219 at or close to the top dead center of cylinder 202. From conduit 219, insulator fluid 220 flows down the inside of a microfluidic internal jacket 222 having fluid passages 214 extending to and terminating at ports 216 on inner surface 203 of cylinder 202. Once in cylinder 202, insulator fluid 220 forms an insulating gas boundary layer (IGBL) 230 between inner surface 203 and combustion chamber 208. In implementations in which insulator fluid 220 is in a gas phase at fluid source 218, the gas is injected through injection ports 216 to provide an IGBL 230 between inner surface 203 and combustion chamber 208. In implementations in which insulator fluid 220 is a liquid at fluid source 218, at least some of the fluid injected into cylinder 202 is flash-evaporated by the heat within combustion chamber 208 to provide IGBL 230 between inner surface 203 and combustion chamber 208. In some implementations, all of the fluid injected into cylinder 202 is flash-evaporated by the heat within combustion chamber 208 to provide IGBL 230.

Although FIG. 2 illustrates large passages 214 and ports 216 in relationship to the apparent dimensions of cylinder 202, this appearance is for illustration purposes only. While inlets (e.g., passages 214 and ports 216) of varying sizes may be employed, in at least one implementation, passages 214 are microfluidic channels in the wall of cylinder 202 leading to microfluidic injection microjets or ports 216 in inner surface 203 of cylinder 202. The microfluidic inlets may typically have channels and ports varying from 1 micrometer to 1 mm in dimension. In some cases, aspects of these passages 214 and ports 216 may be slightly larger or smaller. Passages 214 may be straight or direct as shown in FIG. 2, or may have a tortuous path.

In one implementation, internal jacket 222, passages 214 and ports 216 are engineered to provide a pressure differential between TDC and BDC within internal jacket 222. In another implementation, internal jacket 222, passages 214 and ports 216 are engineered to provide a pressure differential between TDC and BDC within combustion chamber 208. In some implementations, the pressure is greater at TDC than at BDC. The pressure differential between TDC and BDC can vary with time, by piston-stroke timing, or by piston position. In some implementations, the pressure differential between TDC and BDC is as much as 50×, in other implementations as much as 100×.

In various implementations, the pressure differential may be implemented based on varying size, placement, density, etc. of passages 214 and ports 216 in internal jacket 222 between TDC and BDC. Passages 214 and ports 216 of assembly 200 are configured with essentially equal size from TDC to BDC of cylinder 202, but with a greater areal density closer to TDC than BDC of cylinder 202. Because of the single feed conduit 219 proximate TDC of cylinder 202, the pressure within jacket 222 is higher at TDC of cylinder 202 than at BDC, producing higher volume flow through passages 214 and ports 216 at TDC of cylinder 202 than at BDC. Additionally, because of the higher concentration of passages 214 and ports 216 at TDC, the volume flow (or mass flux) of insulator fluid 220 is significantly higher at TDC of cylinder 202 than at BDC. In some implementations, the pressure at TDC is greater than the pressure at BDC, and the volume flow (or mass flux) of insulator fluid 220 is greater at TDC than at BDC. In general, for all implementations, to allow insulator fluid 220 to flow into cylinder 202, the pressure at TDC, BDC, and therebetween, is higher than the pressure within combustion chamber 208.

An insulator fluid pump (such as pump 122 of FIG. 1) may be utilized to pressurize fluid source 218, conduit 219 and jacket 222. In certain implementations, one or more fluid pumps may operate and/or be regulated (such as by regulator 124 of FIG. 1) to maintain a near constant injection jacket pressure. Alternatively, the insulator fluid pump may be modulated with time to adjust to mean cylinder pressures over a cycle as the engine power output is throttled. In some configurations, very high-speed injection jacket pressure modulation may be applied for more optimal engine tuning In one implementation, the fluid pump may be designed to pump the insulator fluid in a liquid form to reduce pump power consumption due to the much higher fluid density of liquid compared to a gas. For implementations where the insulator fluid is a gas, the fluid pup may be a compressor.

Formation of IGBL 230 during the high temperature power stroke in the internal combustion engine is a characteristic of designing the IGBL process for a given power system. After the power stroke, IGBL 230 may become partially mixed into the lower temperature combustion gases after mechanical power has been removed. The exhaust stroke expels the non-homogeneous mix of combustion gases and IGBL gases from cylinder 202 in preparation for the next stroke.

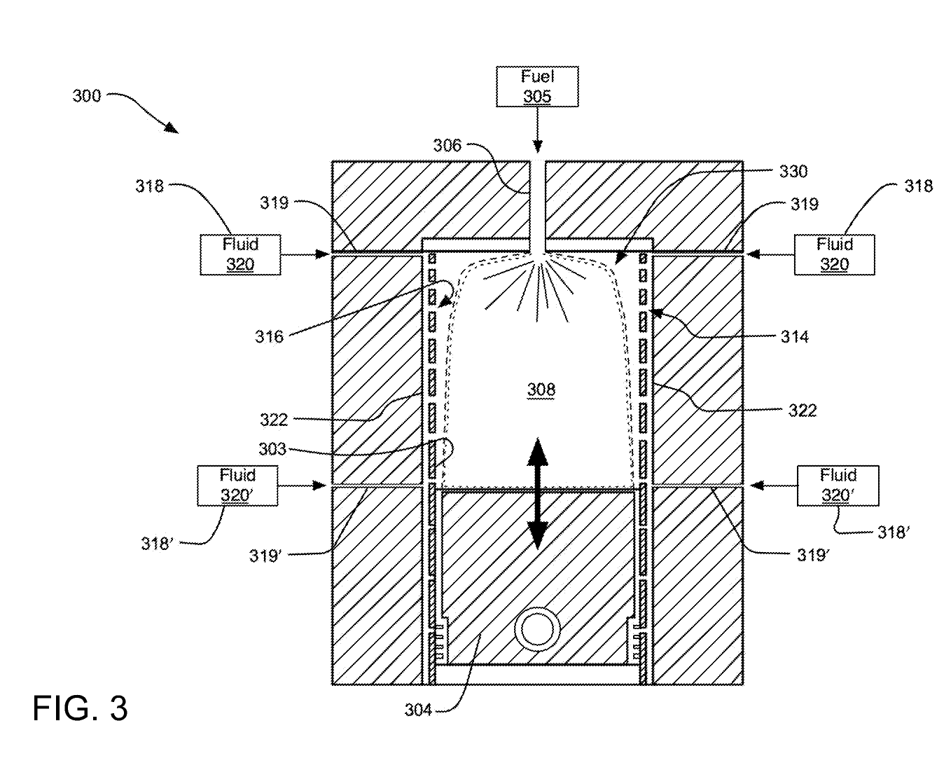

FIG. 3 depicts an alternative example of IGBL-injecting piston and cylinder assembly 300 for an internal combustion engine. Assembly 300 and the various elements thereof in FIG. 3 are generally similar to assembly 200 and the various elements thereof described above with respect to FIG. 2. Similar reference numbers designate similar components, with values increased by one hundred in FIG. 3 as compared to FIG. 2. This component identification convention is followed throughout this disclosure.

Assembly 300 includes cylinder 302, having an inner surface 303, and a piston 304 positioned within cylinder 302, configured to move in and out of the interior of cylinder 302 in a cyclical manner. An energetic working fluid 305 (e.g., a fuel or fuel/air mixture) is injected through a fluid inlet 306 into a combustion chamber 308 of cylinder 302. As energetic working fluid 305 enters combustion chamber 308, in a power stroke cycle of the internal combustion engine, energetic working fluid 305 is ignited near TDC of the piston movement, causing an expansion of gases that forces piston 304 down toward BDC of the piston movement. Although not illustrated, cylinder 302 also includes an exhaust port and an air intake port.

Cylinder 302 includes a plurality of fluid passages 314 through its wall that terminate at a port 316 on inner surface 303. In some implementations, fluid passages 314 and ports 316 may additionally be present through or at the top of cylinder 302. Each of fluid passages 314 and ports 316 is in fluid communication with a first fluid source 318 and a second fluid source 318′ for an insulator fluid 320.

To form an insulating gas boundary layer (IGBL) in cylinder 302, insulator fluid 320 is provided (e.g., injected) from first fluid source 318 into cylinder 302 via a first conduit 319 at or close to TDC of cylinder 302. Additionally in assembly 300, insulator fluid 320′ is provided (e.g., injected) from second fluid source 318′ into cylinder 302 via a second conduit 319′ at or close to BDC of cylinder 302. In some implementations, insulator fluid 320′ is chemically the same as insulator fluid 320, although in other implementations they are different.

From conduits 319, 319′ insulator fluid 320, 320′, if provided as a liquid, converts to a gas and fills inside of a microfluidic internal jacket 322, or, if insulator fluid 320 is provided as a gas, the gas fills the inside of jacket 322. Jacket 322 has fluid passages 314 extending to and terminating at ports 316 on inner surface 303 of cylinder 302. Once in cylinder 302, gas-phase insulator fluid 320, 320′ forms an insulating gas boundary layer (IGBL) 330 between inner surface 303 and combustion chamber 308.

Formation of IGBL 330 during the high temperature power stroke in the internal combustion engine is a characteristic of designing the IGBL process for a given power system. After the power stroke, IGBL 330 may become partially mixed into the lower temperature combustion gases after mechanical power has been removed. The exhaust stroke expels the non-homogeneous mix of combustion gases and IGBL gases from cylinder 302 in preparation for the next stroke.

As in FIG. 2, FIG. 3 illustrates large passages 314 and ports 316 in relationship to the apparent dimensions of cylinder 302, this appearance is for illustration purposes only; it is understood that the inlets (e.g., passages 314 and ports 316) of varying sizes may be employed, in at least one implementation, passages 314 are microfluidic channels in the wall of cylinder 302 leading to microfluidic injection microjets or ports 316 in inner surface 303 of cylinder 302.

In this implementation, passages 314 and ports 316 of assembly 300 are configured to have larger diameter or dimension passages 314 and ports 316 at TDC than at BDC. Because of the double feed conduits 319, 319′ from fluid sources 318, 318′, respectively, the pressure within jacket 322 can be adjusted as needed to achieve the desired pressure and flow volumes at the various locations at inner surface 303. One or more fluid pumps may operate and/or be regulated to maintain the desired injection jacket pressure.

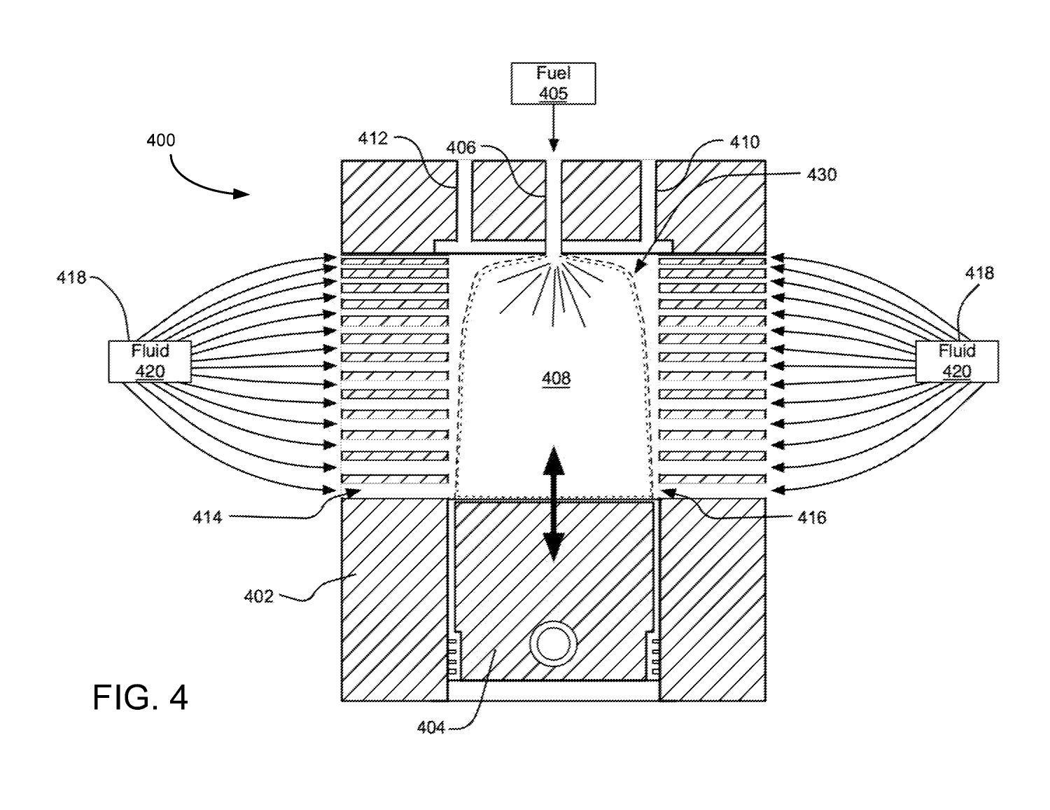

FIG. 4 depicts another alternative example of IGBL-injecting piston and cylinder assembly 400 for an internal combustion engine. Assembly 400 and the various elements thereof in FIG. 4 are generally similar to assembly 200 and assembly 300 and the various elements thereof described above. Similar reference numbers designate similar components, with values increased by a factor of one hundred.

Assembly 400 includes cylinder 402, having an inner surface (not called out), and a piston 404 positioned within cylinder 402, configured to move in and out of the interior of cylinder 402 in a cyclical manner. An energetic working fluid 405 (e.g., a fuel) is injected through a fluid inlet 406 into a combustion chamber 408 of cylinder 402. Cylinder 402 also includes an exhaust port 410 and an air intake port 412.

Cylinder 402 includes a plurality of fluid passages 414 through its wall that terminate at a port 416 on the inner surface. In some implementations, fluid passages 414 and ports 416 may additionally be present through or at the top of cylinder 402. Each of fluid passages 414 and ports 416 is in fluid communication with a fluid source 418 for an insulator fluid 420. To form an insulating gas boundary layer (IGBL) in cylinder 402, insulator fluid 420 is provided (e.g., injected) from fluid source 418 into cylinder 402 via passages 414 and ports 416.

In one implementation, fluid passages 414 and ports 416 are engineered to provide a pressure differential between TDC and BDC along the interior of cylinder 402. In various implementations, the pressure differential may be implemented based on varying size, placement, density, etc. of fluid passages 414 and ports 416 between TDC and BDC. In the illustrated implementation of FIG. 4, insulator fluid 420 is fed to individual fluid passages 414 independently from fluid source 418. Such implementations may include a regulator or other element to control the fluid pressure to and through each individual fluid passage 414. In some implementations, insulator fluid 420 is injected at a higher pressure through injection holes nearer to TDC and at a lower pressure through injection holes nearer to BDC. Such pressure variations may be controlled in coordination or independently. In addition, such pressure variations may be dynamically temporally modified in synchronicity with the piston cycle and/or in accordance with other temporal factors to provide appropriate IGBL coverage.

Formation of IGBL 430 during the high temperature power stroke in the internal combustion engine is a characteristic of designing the IGBL process for a given power system. After the power stroke, IGBL 430 may become partially mixed into the lower temperature combustion gases after mechanical power has been removed. The exhaust stroke expels the non-homogeneous mix of combustion gases and IGBL gases from cylinder 402 in preparation for the next stroke.

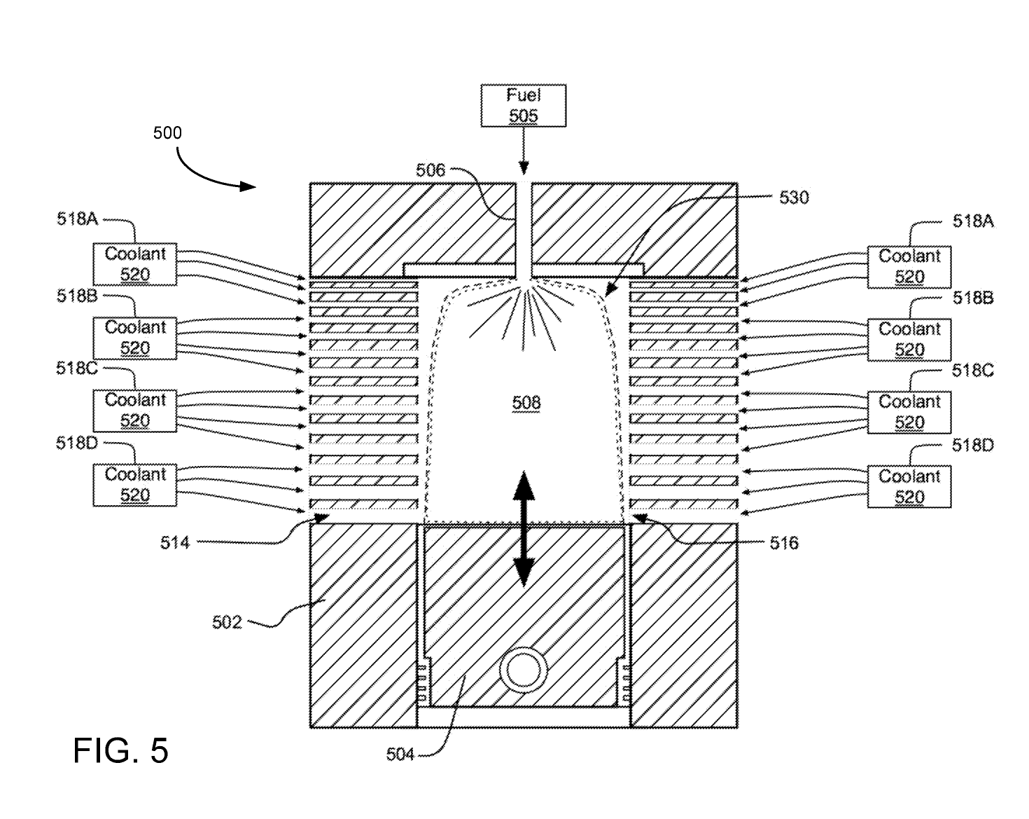

FIG. 5 depicts another alternative example of IGBL-injecting piston and cylinder assembly 500 for an internal combustion engine. Assembly 500 and the various elements thereof in FIG. 5 are generally similar to assembly 200, assembly 300, assembly 400 and the various elements thereof described above. Similar reference numbers designate similar components, with values increased by a factor of one hundred.

Assembly 500 includes cylinder 502, having an inner surface (not called out), and a piston 504 positioned within cylinder 502, configured to move in and out of the interior of cylinder 502 in a cyclical manner. An energetic working fluid 505 (e.g., a fuel) is injected through a fluid inlet 506 into a combustion chamber 508 of cylinder 502. Cylinder 502 also includes an exhaust port and an air intake port, not shown in FIG. 5.

Cylinder 502 includes a plurality of fluid passages 514 through its wall that terminate at a port 516 on the inner surface of cylinder 502. In some implementations, fluid passages 514 and ports 516 may additionally be present through or at the top of cylinder 502. Each of fluid passages 514 and ports 516 is in fluid communication with a fluid source for an insulator fluid 520, in this implementation four individual fluid sources 518A, 518B, 518C, 518D. To form an insulating gas boundary layer (IGBL) in cylinder 502, insulator fluid 520 is provided (e.g., injected) from fluid sources 518A, 518B, 518C, 518D into cylinder 502 via passages 514 and ports 516.

Fluid passages 514 and ports 516 are engineered to provide a pressure differential between TDC and BDC along the interior of cylinder 502. The pressure differential may be implemented based on varying size, placement, density, etc. of fluid passages 514 and ports 516 between TDC and BDC. In the illustrated implementation of FIG. 5, insulator fluid 520 is fed by fluid sources 518A, 518B, 518C, 518D to fluid passages 514. In the particular implementation, fluid source 518A supplies the top three fluid passages 514 and ports 516, fluid sources 518B, 518C each supply four mid- fluid passages 514 and ports 516, and fluid source 518D supplies the bottom three fluid passages 514 and ports 516. Insulator fluid 520 can be injected at a different pressures along the length of cylinder 502; such pressure variations may be controlled in coordination or independently. In addition, such pressure variations may be dynamically temporally modified in synchronicity with the piston cycle and/or in accordance with other temporal factors to provide appropriate IGBL coverage.

Formation of IGBL 530 during the high temperature power stroke in the internal combustion engine is a characteristic of designing the IGBL process for a given power system. After the power stroke, IGBL 530 may become partially mixed into the lower temperature combustion gases after mechanical power has been removed. The exhaust stroke expels the non-homogeneous mix of combustion gases and IGBL gases from cylinder 502 in preparation for the next stroke.

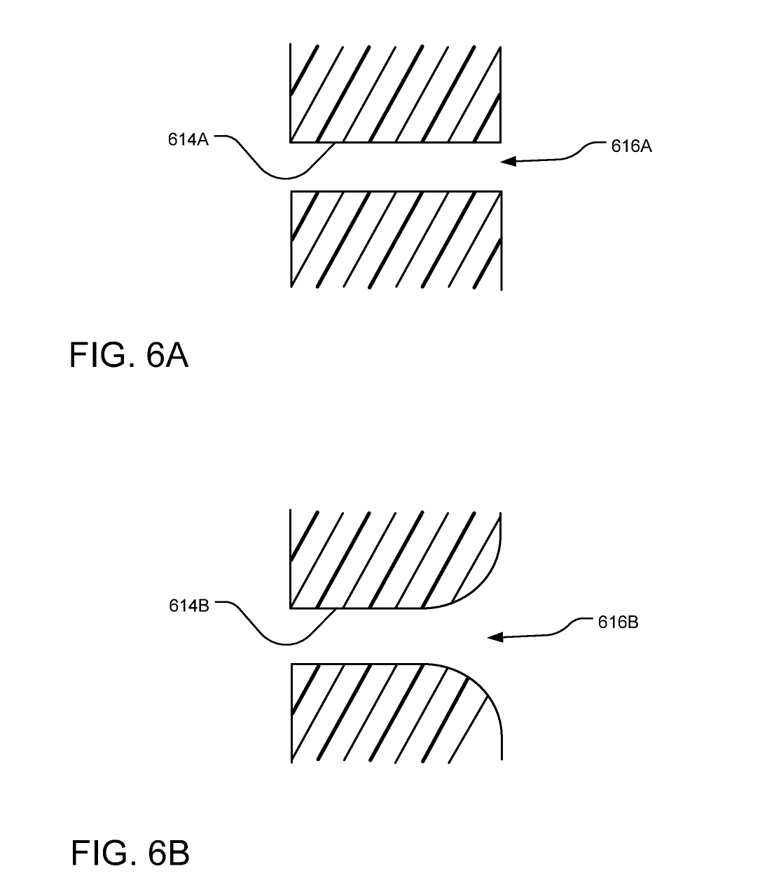

FIGS. 6A and 6B illustrate two examples of suitable fluid passages and ports for use with any of assemblies 200, 300, 400 and 500. FIG. 6A illustrates a fluid passage 614A through a cylinder wall, fluid passage 614A terminating at port 616A on an inner surface 603A of the cylinder. This implementation has fluid passage 614A with constant diameter along its length through the cylinder wall, terminating at port 616A which has the same diameter as passage 614A. FIG. 6B illustrates a fluid passage 614B through a cylinder wall, fluid passage 614B terminating at port 616B on an inner surface 603B of the cylinder. This implementation has fluid passage 614B with a varying diameter along its length through the cylinder wall, terminating at port 616B which has a greater diameter than passage 614B. Passage 614B has a smooth, trumpet-like transition, and may be referred to as a venturi. In other implementations, the fluid passage can have a stepped diameter change. In other implementations, the fluid passage can have a convergent-divergent shape; such a fluid passage may be referred to as a De Laval nozzle. Such a nozzle, with sufficient pressure ratio, may achieve supersonic velocities to expedite formation of the IGBL boundary layer of sufficient boundary layer thickness under high speed piston operations.

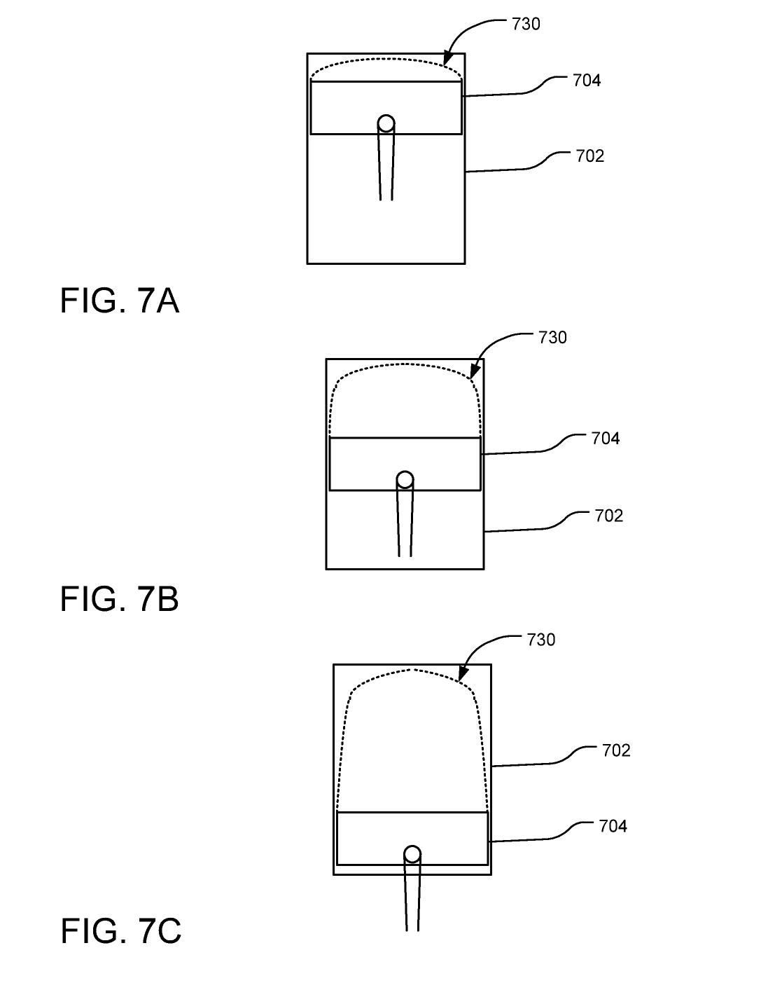

FIGS. 7A, 7B and 7C illustrates temporal variations in an insulating gas barrier layer relative to the core combustion gases at three stages during the power stroke cycle of the internal combustion engine. In some implementations, such as a typical consumer automobile, a power stroke occurs in about 10 to 30 milliseconds, whereas in other implementations, such as a race car, a power stroke occurs in less than about 10 milliseconds. Although a single dashed line is shown in the figures, in practice, the gas boundary is “blurred” by mixing and mass diffusion of the gases in the IGBL with the gases in the combustion chamber. Variation in the IGBL effective thickness is affected by the instantaneous combustion chamber pressure, the temperature distribution and corresponding density distribution of gas across the IGBL, and the amount of local injected IGBL mass flux as a function of time. In some implementations, the pressure at which the insulator fluid is injected into the combustion chamber is temporally modified in synchronicity with a piston cycle.

Each of FIGS. 7A, 7B and 7C show a cylinder 702, a piston 704 movably positioned within cylinder 702, and an insulating gas barrier layer (IGBL) 730. Cylinder 702 has a cylinder axis extending from TDC and BDC, along which piston 704 moves. In FIG. 7A, when piston 704 is at or near top dead center (TDC), IGBL 730 is predominantly present at TDC and has a pressure. In FIG. 7B, when piston 704 has been forced down away from TDC toward bottom dead center (BDC) due to expanding gases from the combustion of the working fuel, IGBL 730 extends toward BDC and the thickness of IGBL 730 at TDC has increased. With this position of piston 704, the pressure of IGBL 730 is less than the pressure of IGBL 730 in FIG. 7A. In FIG. 7C, when piston 704 has been forced to BDC, IGBL 730 extends to BDC and the thickness of IGBL 730 at TDC is increased over that of FIG. 7B. With this position of piston 704 at BDC, the pressure of IGBL 730 is less than the pressure of IGBL 730 in FIG. 7B.

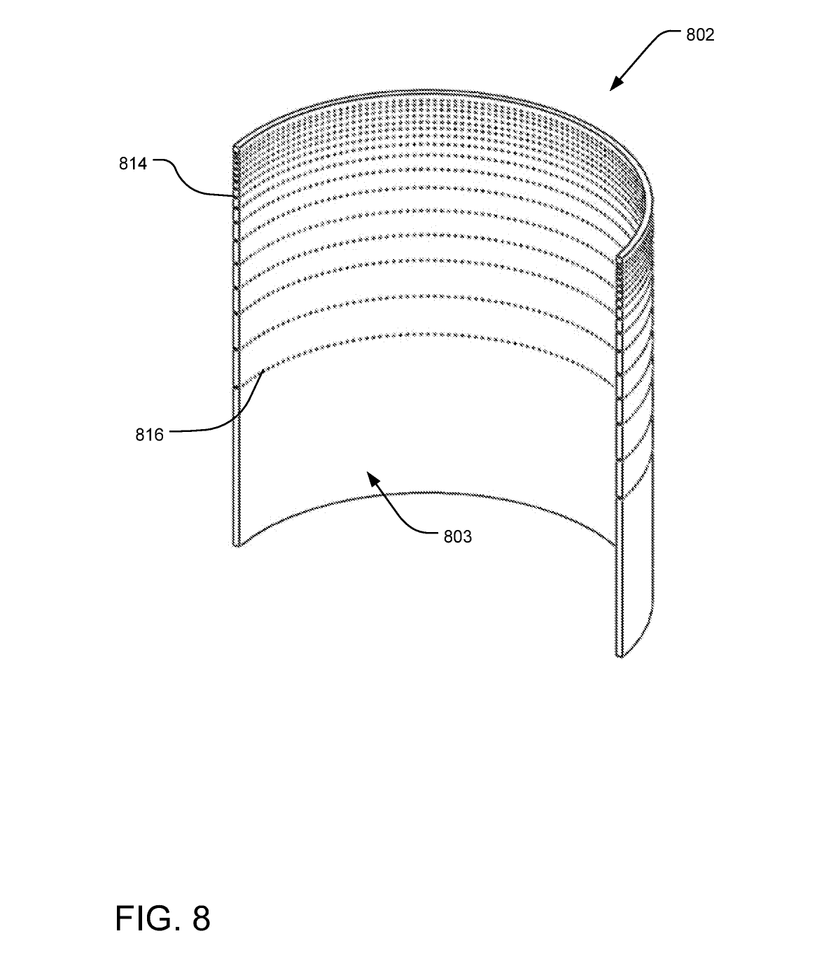

FIG. 8 is a three-dimensional partial illustration of a cylinder suitable for use with an IGBL assembly. Cylinder 802 has an inner surface 803 and a plurality of fluid passages 814 extending through the cylinder wall to inner surface 803, where fluid passages 814 terminate at fluid injection ports 816. In the implementation illustrated in FIG. 8, passages 814 and ports 816 are axially distributed along the height of cylinder 802, with the density of passages 814 and ports 816 greater proximate TDC of cylinder 802 and decreasing towards BDC. In the illustrated implementation, no fluid passages or ports are present directly at BDC. Additionally in the illustrated implementation, fluid passages 814 and ports 816 are arranged in linear rows extending circumferentially around inner surface 803. In other implementations, passages 814 and ports 816 are irregularly and/or randomly spaced around inner surface 803.

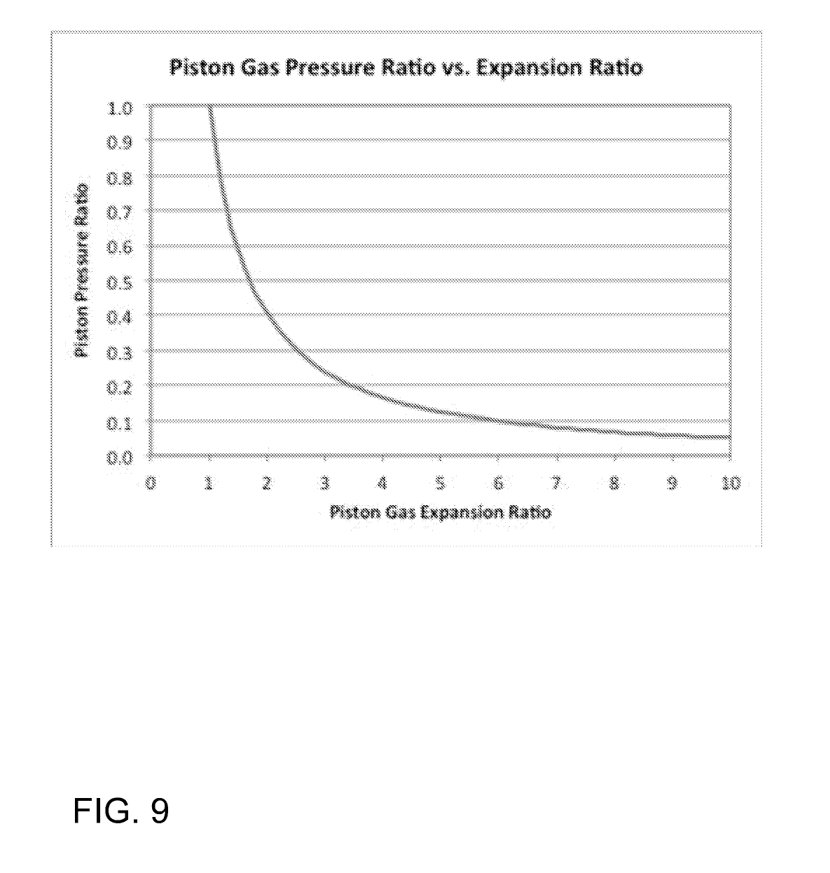

FIG. 9 is a graphical representation of pressure ratio versus piston expansion ratio. This graph shows that the pressure ratio at TDC of a piston is significantly greater than the pressure ratio at BDC, and that the decrease is logarithmic. The data justifies an axial distribution of fluid passages and ports along the height of the cylinder from TDC to BDC. This data also justifies forming a variable pressure distribution in the IGBL from TDC to BDC.

For IGBL-applications in an interior combustion engine, the fluidic and microfluidic features are configured to provide insulator fluid to the interior of the cylinder to produce an insulating gas boundary layer that protects the cylinder wall from heat and corrosion. These features may also allow transpirational cooling of the cylinder wall. The insulator fluid is flowed to just outside of the cylinder wall before injection (e.g., inside the insulator fluid injection jacket or in the inlet). To control turbulence during injection of energetic working fluid into the engine cylinder, the insulator fluid may be injected through thousands to millions of microjets in a uniform distribution with average jet port diameters between about 1 micrometer to about 2 mm on the inner surface of the cylinder to help control and avoid upsetting the IGBLs produced elsewhere in the cylinder. In an alternative implementation, the injection distribution may be distributed in a non-uniform fashion to manage the profile of the IGBLs throughout the interior of the cylinder. In other implementations, the insulator fluid may be injected through significantly less microjets or ports, for example, about 10, about 50 or about 100 microjets, or, at least 10, at least 50 or at least 100 microjets. In some cases, the average jet port diameters may be slightly smaller or larger than about 1 micrometer and about 1 mm respectively. The circumferential spacing between jets may be between about 10 micrometer to about 10 mm respectively. The axial spacing between jets may vary between about 10 micrometer to about 10 cm respectively.

The fluidic features, such as the jacket, and microfluidic features, such as the fluid passages and ports (e.g., fluid passages 214, 314, etc. and ports 216, 316, etc.) may be made by any suitable technology. One general suitable technology is broadly known as net shape manufacturing. With such technology, engineered porous materials (e.g., foams) having a controlled network of capillaries and/or pores, can be formed.

In certain implementations, the features are etched into thin layers of material (e.g., nickel, aluminum, stainless steel). The engineering/fabrication process is controlled at the microscopic level, so that high volume 3-dimensional structures (e.g., cylindrical structures) with many hundreds to tens of millions of embedded 3-dimensional fluid passages can be very efficiently etched and produced inexpensively. The combustion chamber in the interior of the cylinder is machined/bored out is a subsequent process.

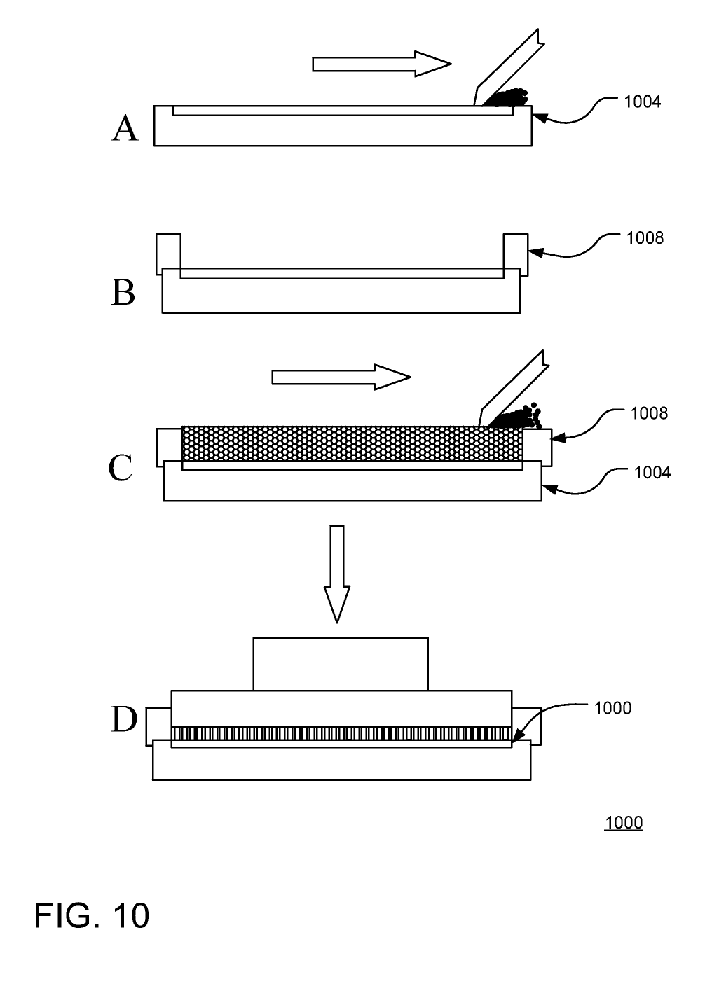

In other implementations, plastic state mold process (PSMP) can be used to create very thin elements that may be pre-sintered as thin membranes and subsequently merged with other pre-sintered elements in a process termed merging. One embodiment is shown in steps A-D of FIG. 10. Merging is a process whereby a pre-molded porous element made of materials with one pore size, is pressed onto another pre-molded element, made material of second (different, and often smaller, pore size). Merging may also include stacking more than two pre-molded elements into multiple layers of elements with varying densities. The stack of elements is subsequently heated and pressed to create variable porous layering within a single part, as shown as step D in FIG. 10. The sintering/pressing process may also include a method for evacuating or displacing the oxygen from the process at sintering temperatures to avoid oxidation decomposition of the part. The equivalent of pressing may also be done by heating the part under fixed constraints such that a large internal pressure is applied throughout the part.

More particularly, FIG. 10 illustrates one embodiment for the procedure for fabricating a structure with tiered porosity suitable for assemblies such as, e.g., assembly 500 of FIG. 5. Step A in FIG. 10 shows a cross sectional view illustrating the operation of “striking off” a first layer of a PSMP produced composite within a mold 1004. Step B shows a second mold 1008 being placed atop the first. Step C shows the striking off of the second layer of material onto a surface of the first layer. Step D shows how sintering heat and force are used to consolidate the layers into a single variable density element 1000 having tiered pore sizes.

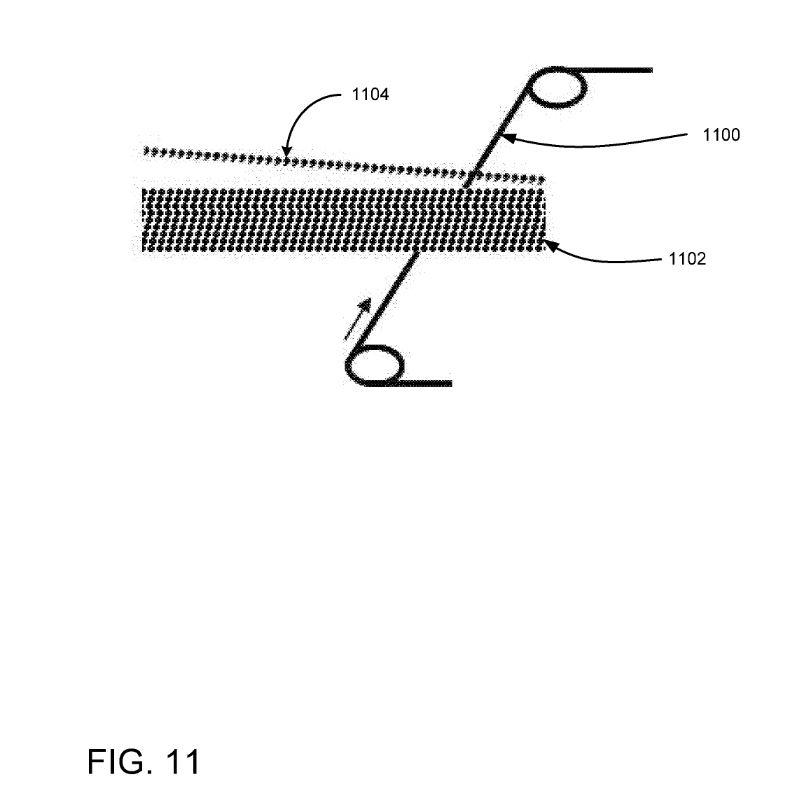

In other implementations, electrical discharge machining (EDM) can be used to fabricate tiered porosity elements; FIG. 11 illustrates such an implementation. In this process, an EDM wire 1100 is used to slice a preformed microfluidic porous media plug 1102 to produce a very thin slice 1104 (typically<about 0.076 cm (0.030 in)) microfluidic porous media element. Similar to the merging process of FIG. 10, this small pored structure can go through an oxidation reduction process and a merging process to combine the thin sliced microfluidic porous media element to another mechanical structure that provides sufficient mechanical backing and fluid wetting, if needed.

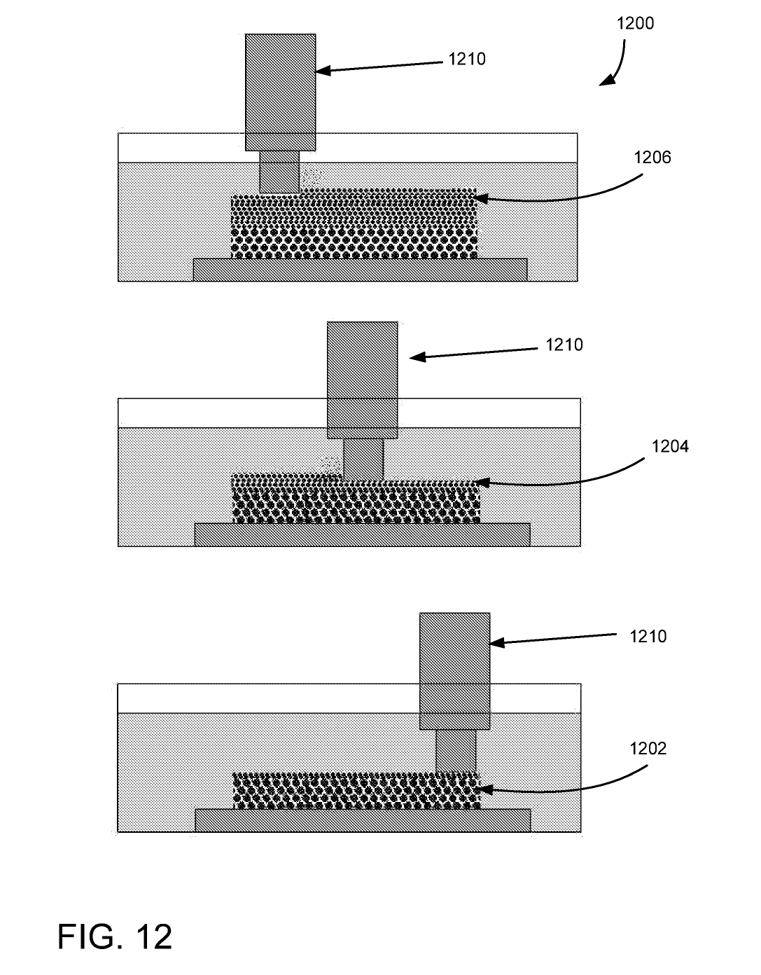

FIG. 12 illustrates an implementation of the procedure for fabricating tiered porosity elements using electrical discharge machining (EDM) on prebonded layers or regions. In this process, a microfluidic porous media element is diffusion bonded using, for example, an oxidation reduction process (as required) and a merging process. An EDM wire or plunge EDM 1210 is used to remove excess micro-fluidic porous media material until only a very thin region overlies and is prebonded to the low-pressure drop, larger diameter pore, porous media 1202.

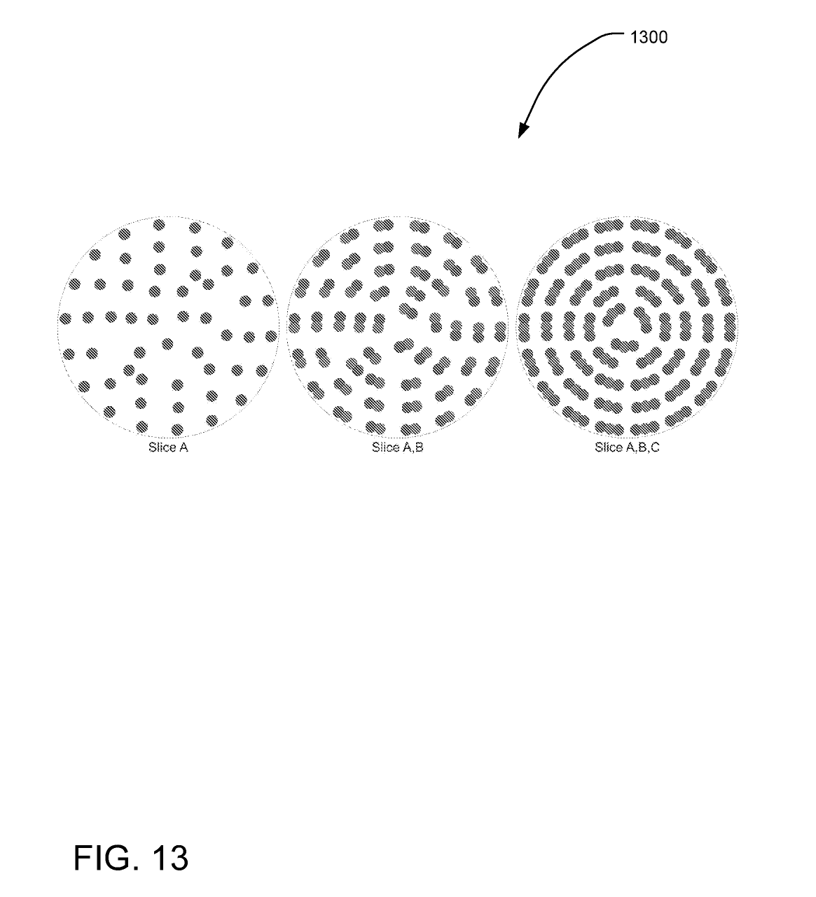

FIG. 13 shows another implementation of fabricating a tortuous path microfluidic porous media that comprises using integrated circuit processing methods to form silicon microfluidic porous media, silicon dioxide, silicon nitride or metal microfluidic porous media; the process uses a standard masking process. A thin (e.g., about 200 micrometer thick silicon, silicon dioxide (or in the case of silicon nitride or metal, a film, for example) is coated with a photoresist, covered by a mask, exposed to develop the mask, etched by either anisotropic or isotropic processes such as BOE, HF, KOH, RIE or similar process. The mask is removed, and the wafer or film is released as a thin layer. Several microfluidic porous media elements may be fabricated on a single wafer or film. The microfluidic porous media elements may be masked again, and etched away from the wafer structure, leaving the separate micro-fluidic porous media elements. The individual slices are then bonded using a method such as anodic bonding, annealing or fusing, or similar method. During bonding, each slice is registered, a process by which one slice is placed atop another, aligned with fiducials placed during fabrication.

The process of registering each slice is shown in FIG. 13, which shows how the use of rotation of one element slice with respect to another may define small, definable-size paths. The size of the paths, given appropriate fabrication, will vary continuously from fully open to submicron sizes depending on the degree of rotation of each micro-fluidic porous media slice. This alignment allows for different pore sizes without necessarily requiring a new mask and processing for each pore size desired. This process may also be used to accomplish a continuous, smoothly curved or a jagged path, depending on the desired tortuousity.

FIG. 13 is a top down view of a step 1300 of the method using integrated circuit processing methods to produce a microfluidic porous media comprising three stacked microfluidic porous media elements. The diagrams show the overlap of each layer with the registration of Slice A, relative to Slice B, relative to Slice C.

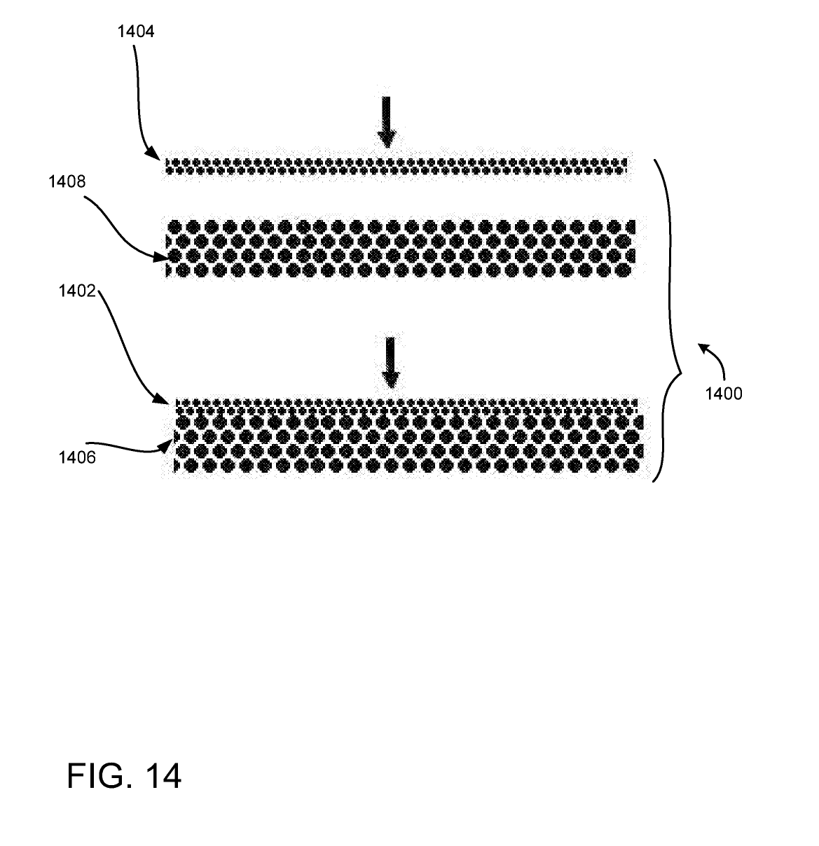

FIG. 14 illustrates a tiered-porosity element 1400 incorporating multiple small porosity thin elements 1402, 1404 into larger porous media regions 1406, 1408 to provide tiered porosity.

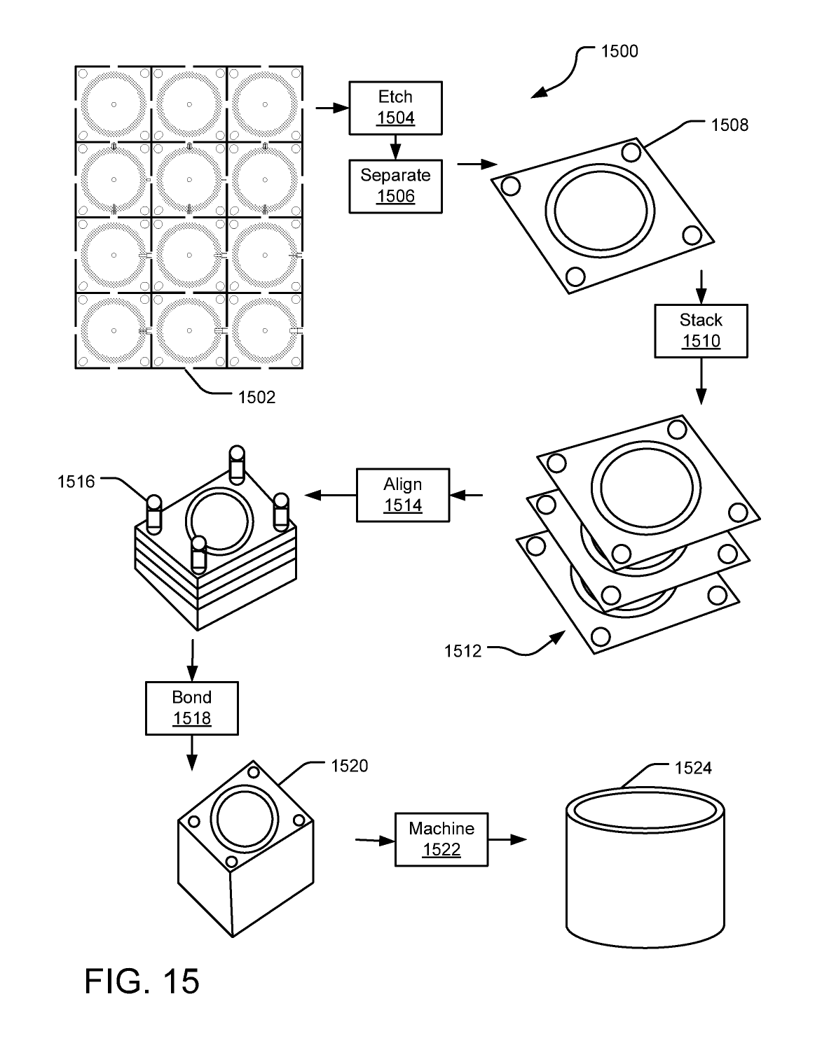

As another example, a photolithograph method for producing either tiered porosity, consistent porosity, or other arrangement of pores (fluid passages and ports) is outlined in FIG. 15. In a stacked and bonded manufacturing lithographic method, finite layers are fabricated which, when stacked and bonded (along the axis of the engine), constitute the cylinder wall including the combustion chamber, and the various passages and holes leading to the combustion chamber.

The inside dimension of the porous media varies to follow the combustion chamber or cylinder contour, and the outside diameter of the porous media will vary to control the jacket gap and microfluidic geometry in order to control cooling while controlling pressure drop through the jacket. The three dimensional porous media jacket is built up in stacked layers and typically diffusion-bonded (applying heat and pressure) to allow the individual layers to bond and form a monolithic structure. The combustion chamber of the cylinder can subsequently be machined out from this monolithic block providing a sealed wall separating the combustion chamber from the jacket as well as a sealed outer jacket wall. To accommodate this three dimensional geometry in at least one implementation, each layer is positioned perpendicular to the cylinder axis defined by TDC and BDC. The finite layers contain all the features that, when stacked on top of each other, create the desired arrangement of fluid passages and ports. Therefore, the layers include features that allow for fluid flow from the entry fluid conduit to the cylinder inner surface.

In some implementations, porous media outside of the inside cylinder may also be used to modify the local effective thermal conductivity of the cylinder wall to reduce heat loss from the piston cylinder. For example, although the IGBL significantly reduces convective and conductive heat transport with the hot combustion gases, in many cases, radiative heat transport from the combustion gases may still pass through the IGBL with little absorption. To reduce these thermal losses, micro-fluidic porous media contained within the wall that produces a tortuous path for heat flow may significantly increase the insulating properties of the cylinder wall.

In some implementations, the insulator fluid is evaporated prior to injection into the cylinder by efficiently coupling heat from the combustion chamber into the insulator fluid prior to the insulator fluid being injected into the cylinder via the fluid passages and ports. For such implementations, small effective diameter fluid passageways and fluid passageways with enhanced tortuosity of the fluid path may help augment the transport of heat into the fluid to help facilitate rapid flash-evaporating of the insulator fluid.

The features defining the porous media will usually be contained within an annulus between the jacket and inner surface of the cylinder. Typically, the design is laid out in sheets, with each element of the sheet representing a single layer of the stacked structure. Each layer includes a ring of porous media material that has been etched or otherwise applied to the layer. Further, the diameter of the ring of porous media is specific to that layer and its position in the stack. The individual layers can incorporate features, in addition to the jacket, fluid passages and ports, such as fluid conduit(s) to the jacket.

Closely spaced hexagons are one good approximation of a finite layer of porous media, though closely spaced squares, rectangles, arc sections, or other cross-sectional shapes can also be used. The location of the selected shapes is often offset between different layers. By drafting these repeating shapes in the area constrained between the porous media's outside and inside diameter, and adding features to define other fluid passages, a design for a finite layer of the cylinder can be created. A sheet of lithographic design of these patterns dictates where material is to be removed from each metal layer. As the cuts required to approximate porous media can be complex, it is advantageous to use a computer program for this design stage.

The extent of overlap of the hexagons or other shape determines the tortuosity of the path of any fluid going through the cylinder wall. This size of the individual shapes and the overlap between layers is under the control of the designer, and thus materials can be made of the desired porosity or tortuosity. The selection of desired pore size for specific systems depends upon the physical and thermal characteristics of the fuel and the cooling fluid being used.

Turning to FIG. 15, as an initial operation, the lithographic design 1502 is applied to metal components (e.g., foil layers). This application process may be accomplished by a number of methods. For example, masking and chemically etching metal foils provides a repeatable and reliable method to fabricate layers. This process can be started by transferring the design to a transparent material in order to create a lithographic mask. Next, an ultraviolet sensitive material is applied to the foil material that constitutes the individual layers of the cylinder. When the mask is placed over the UV-sensitive material, applying UV light to the combination causes the UV-sensitive material to harden in specific areas to protect those areas from etching. That is to say, every area that the UV sensitive material does not receive UV light (i.e., those areas obscured by the mask) can be chemically removed, leaving only the foil areas that are covered with a hardened protective coating of UV-sensitive material.

An etching operation 1504 removes the metal material that is not covered by the hardened UV-sensitive material. In one implementation, the etching is accomplished by placing the foils in a chemical bath. A separating operation 1506 separates the etched metal foils from one another to yield individual foil layers (such as layer 1508). A stacking operation 1510 stacks the individual layers; an example stack of layers is shown in as stack 1512. An aligning operation 1514 aligns the stacked layers to maintain precision flow paths, as shown in aligned stack 1516. Alignments can be accomplished by datum planes, alignment pins, or some other suitable jig.

A bonding operation 1518 bonds the individual layers to form a single block 1520 from the many individual layers. Bonding can make use of an auxiliary joining agent; however, it may be advantageous to use diffusion bonding. One type of bonding that may be employed is “laminated foil bonding”, although other types of bonding may be used. Another type of bonding that may be employed is “laminated foil strain-limited solid-state diffusion bonding.” Bonding of all layers forms the single block 1520 from the many individual layers.

Bonding of layers may also be done in subunits (in which multiple layers constitute one subunit). An individual subunit may be bonded (e.g., using laminated strain-limited solid-state diffusion bonding), and then multiple subunits may be subsequently bonded together to form the entire jacket structure. In some implementations, the layers are bonded in subunits of approximately one-fifth to one tenth of the total layers, and then the five to ten subunits are bonded together. The method of building and then bonding subunits may diminish the possibility of distortion caused by bonding individual layers over a complete cylinder structure.

In addition, bonding may be performed by a method known as “strain bonding”. In this method, the layers are aligned and placed between two inflexible ceramic panels. When heat is applied to this sandwich structure, the metal of the lithographic layers heats. As the metal heats, it tries to expand, generating large internal pressures that help cause the adjacent layers to diffusion bond.

Following bonding operation 1518, a machining operation 1522 machines block 1520 to its final dimensions, yielding a porous media element 1524. In one implementation, because the bonding process requires alignment and uniform pressure, it is not practical to fabricate the cylinder with final dimensions pre etched, although other implementations may allow pre-etching.

Block 1520, containing the contoured porous media internal to the structure, is machined to final dimensions. A number of methods can be used to perform the machining, but traditional metal fabrication methods (e.g., milling, lathing, grinding, and drilling) are generally acceptable. The final element 1524 can then receive any auxiliary hardware required to operate/measure the cylinder (e.g., inlet ports, exhaust outlet, etc.).

In summary, FIG. 15 demonstrates a process for creating a porous media element from a stacked and bonded structure. The process is initiated by applying patterned designs to individual layers of metal components. The application process may include, without limitation, chemical etching, laser cutting, machining (CNC or manual), punching, sheering, electrical discharge machining (EDM), water jet cutting, plasma cutting, or any combination thereof, although chemical etching has been found particularly well suited to fabricate quantities of thin foils with very repeatable results. Individual layers are stacked in alignment and then bonded to form a block having a three dimensional fluid path in a channel between an impermeable inner wall and an impermeable outer wall. The interior and exterior profiles of the block are machined to yield the regeneratively cooled porous media jacket in final dimensions. The machining operation can employ conventional machining (CNC or manual), EDM, grinding, or any combination thereof. The completed jacket can receive inlet ports, measurement ports, an injector heads, a pressure cap, ignition mechanisms and auxiliary hardware for mechanical interface or measurements.

Other suitable methods for forming porous elements are taught in U.S. Pat. No. 8,413,419 (Mungas et al.) and in U.S. Patent Application Publication 2011/0146231 (Mungas et al.), the entire contents of which are incorporated herein by reference.

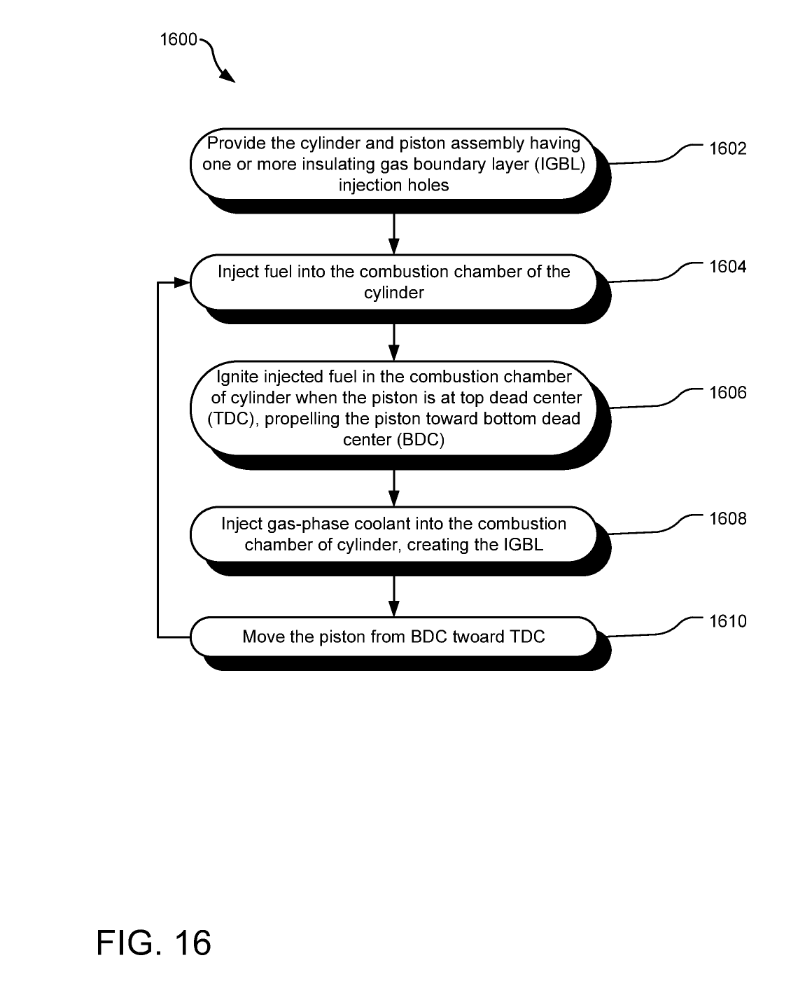

FIG. 16 illustrates example operations 1600 for injecting an IGBL into an internal combustion chamber of a piston and cylinder assembly, such as those of FIGS. 2 through 5. A providing operation 1602 provides an internal combustion engine including a cylinder and piston assembly having one or more IGBL injection holes. An injection operation 1604 injects an energetic working fluid (e.g., a fuel/oxidizer blend or separate flows of fuel and oxidizer) into the combustion chamber of the cylinder. An ignition operation 1606 ignites the energetic working fluid in the combustion chamber, causing an increase of gas pressure that forces the piston down toward BDC of the piston movement. An insulator fluid injection operation 1608 injects an insulator fluid through injection holes into the combustion chamber of the cylinder. The insulator fluid is either an insulator gas or is a liquid that is flash-evaporated to provide an IGBL around the interior of the cylinder (e.g., between the inner surface of the cylinder and the combustion chamber). A compression stroke operation 1610 forces the piston from BDC toward TDC, and the injection operation 1604 is performed again, repeating operations 1604, 1606, 1608, and 1610 in a cyclical or concurrent manner.

It should be noted that the injection operation 1604, the ignition operation 1606, and the insulator fluid injection operation 1608 need not be strictly performed in the illustrated order. These operations may be reordered and/or performed concurrently as appropriate to provide the desired efficiency of the internal combustion engine.

In the following description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. An assembly comprising:
a cylinder having an inner surface and a combustion chamber;
a piston moveably positioned in the cylinder; and
one or more insulator fluid injection ports in the inner surface of the cylinder, the ports configured to transfer an insulator fluid into the cylinder forming an insulating gas boundary layer between the inner surface of the cylinder and the combustion chamber.

2. The assembly of claim 1, wherein the one or more fluid injection ports are individually fed with the insulator fluid.

3. The assembly of claim 2, wherein the one or more fluid injection ports each has an individually controlled fluid pressure therethrough.

4. The assembly of claim 1, wherein a fluid pressure through the one or more fluid injection ports varies from top dead center of the cylinder to bottom dead center of the cylinder.

5. The assembly of claim 1, wherein a spacing of the one or more fluid injection ports varies from top dead center of the cylinder to bottom dead center of the cylinder.

6. The assembly of claim 1, wherein a dimension of the one or more fluid injection ports varies from top dead center of the cylinder to bottom dead center of the cylinder.

7. The assembly of claim 1, wherein the one or more fluid injection ports provide a pressure differential between top dead center and bottom dead center of a piston stroke.

8. The assembly of claim 1, wherein the one or more fluid injection ports provide the insulating gas boundary layer with a pressure between top dead center and bottom dead center.

9. The assembly of claim 8, wherein a pressure differential between top dead center and bottom dead center varies within a piston cycle.

10. The assembly of claim 1, wherein the one or more fluid injection ports are in fluid communication with a microfluidic jacket.

11. The assembly of claim 1, wherein the insulator fluid is a liquid that converts to the gas phase upon transfer through the fluid injection port to form the insulating gas boundary layer between the inner surface of the cylinder and the combustion chamber.

12. The assembly of claim 1, wherein the insulator fluid is a liquid, at least a portion of which converts to the gas phase upon transfer through the fluid injection port to form the insulating gas boundary layer between the inner surface of the cylinder and the combustion chamber.

13. A cylinder comprising:
a cylinder wall having an inner surface encompassing a combustion chamber;
one or more insulator fluid injection ports along the inner surface of the cylinder wall; and
one or more insulator fluid passages configured to receive insulator fluid and transfer the insulator fluid through the one or more insulator fluid ports forming an insulating gas boundary layer at an interior surface of the combustion chamber.

14. The cylinder of claim 13, wherein the one or more insulator fluid inlets are present along the inner surface of the cylinder wall between top dead center and bottom dead of a piston stroke within the cylinder.

15. The cylinder of claim 13, wherein a fluid pressure through the one or more fluid injection ports varies from top dead center of the cylinder to bottom dead center of the cylinder.

16. The cylinder of claim 13, wherein a spacing of the one or more fluid injection ports varies from top dead center of the cylinder to bottom dead center of the cylinder.

17. The cylinder of claim 13, wherein a dimension of the one or more fluid injection ports varies from top dead center of the cylinder to bottom dead center of the cylinder.

18. The cylinder of claim 13, wherein the one or more insulator fluid ports and the one or insulator fluid passages are configured to be individually fed with insulator fluid from a fluid source.

19. The cylinder of claim 13, wherein the one or more insulator fluid ports have a circumferential spacing therebetween of about 10 micrometer to about 10 mm.

20. The cylinder of claim 13, wherein the one or more insulator fluid ports generate fluid jets have a diameters of about 1 micrometer to 2 mm.

21. The cylinder of claim 13, wherein the one or more insulator fluid ports have an axial spacing therebetween of about 10 micrometers to about 10 cm.

22. The cylinder of claim 13 comprising at least 10 insulator fluid injection ports and at least 10 insulator fluid passages.

23. The cylinder of claim 13, wherein the one or more insulator fluid ports and the one or insulator fluid passages provide a pressure differential between top dead center and bottom dead center of a piston stroke within the cylinder.

24. The cylinder of claim 13, wherein the insulating gas boundary layer has a pressure differential between top dead center and bottom dead center of a piston stroke that varies with time.

25. The cylinder of claim 13, wherein the one or more insulator fluid injection passage are in fluid connection with a microfluidic jacket in the cylinder wall.

26. A method comprising:
providing a cylinder having an inner surface and a combustion chamber; and
injecting insulator fluid in gas phase into the cylinder, the gas-phase insulator fluid forming an insulating gas boundary layer between the inner surface of the cylinder and the combustion chamber.

27. The method of claim 26, further comprising, prior to injecting insulator fluid in gas phase into the cylinder, providing liquid phase insulator fluid.

28. The method of claim 26, wherein forming the insulating gas boundary layer comprises forming a pressure differential in the insulating gas boundary layer.

29. The method of claim 26, wherein injecting insulator fluid in gas phase into the cylinder comprises injecting insulator fluid through one or more insulator fluid ports present on the inner surface of the cylinder.

30. The method of claim 26, wherein injecting insulator fluid comprises injecting insulator fluid through two insulator fluid ports at different pressures.

31. The method of claim 30, wherein injecting insulator fluid through two insulator fluid ports is temporally modified in synchronicity with a piston cycle.
